(19) United States
(12) Patent Application Publication
(10) Pub. No.: US 2011/0139558 A1
(43) Pub. Date: Jun. 16, 2011

(54) BARREL-TYPE ROTARY DAMPER

(76) Inventor: Antonino Cultraro, Rivoli Torino (IT)

(21) Appl. No.: 12/997,523

(22) PCT Filed: May 5, 2009
(86) PCT No.: PCT/EP09/03202

§ 371 Date: Jan. 28, 2011

(30) Foreign Application Priority Data
Jun. 13, 2008 (IT) TO2008U000083

(51) Int. Cl. F16F 9/34; F16F 9/14

(52) U.S. Cl. 188/322.15; 188/322.19

(57) ABSTRACT

A rotary damper (10) is disclosed, which comprises a cylindrical housing (12), a rotor (16), and a closure assembly (21; 21′; 21″). The cylindrical housing, rotor and closure assembly cooperate so as to contain a braking chamber (30) having an arcuately extending transverse section and containing a viscous braking fluid. The rotor (16; 16′) comprises a piston element or portion (31) extending radially from the rotor (16; 16′), and arranged within the braking chamber (30) so as to separate it into two separate regions (30a, 30b) in mutual fluid communication. The braking chamber (30) is formed in a shoulder portion (13b) of the lateral wall (13) of the cylindrical housing (12), and the fluid communication between the two separate regions (30a, 30b) of the chamber (30) is obtained through a channel (35) formed on a shoulder surface (14) of the shoulder portion (13b) of the cylindrical housing (12). The channel is interposed between such shoulder portion and the closure assembly (21; 21′; 21″).

The present invention refers to a rotary damper comprising:
a cylindrical housing, having a lateral wall provided with a shoulder portion;
a rotor, which is coaxially mounted within the cylindrical housing, and is rotatable with respect thereto;
a closure assembly, which is sealingly mounted on an axial end of the cylindrical housing at a shoulder surface of the shoulder portion of the cylindrical housing, and has a through opening through which a shaft portion of the rotor protrudes;
in which said cylindrical housing, rotor and closure assembly cooperate so as to contain a braking chamber having an arcuately extending transverse section and containing a viscous braking fluid, and
in which the rotor includes a piston element or portion radially extending from the rotor, and arranged inside the braking chamber in such a way as to separate said chamber in two separate regions in mutual fluid communication, said piston element or portion being movable integrally with the rotor so that a rotation of the rotor produces a rotary movement of the piston element or portion which is braked by the resistance to the flow of fluid from a region to the other of the braking chamber caused by the movement of the piston element or portion.

A device of this type is for instance known from the Austrian patent AT 393 005 B.

An object of the present invention is that of realizing a rotary damper which is able to get high braking torques, and which is simple to manufacture.

Such an object is reached according to the invention by a rotary damper of the type defined at the beginning, in which
the braking chamber is formed in the shoulder portion of the lateral wall of the cylindrical housing, and is delimited on the radially inner side and on an axial end by the rotor and by the closure assembly, respectively; and in which
the fluid communication between the two separate regions of the chamber is obtained through a channel formed on the shoulder surface of the shoulder portion of the cylindrical housing, said channel being interposed between said shoulder portion and said closure assembly.

In such a device, thanks to the fact that the chamber is formed in the shoulder portion of the lateral wall of the housing (that is, in the part of the wall having a greater thickness), and that therefore the radially outer surface of the rotor is in contact with the radially inner surface of the housing (except from of the part thereof facing on the braking chamber), it is possible to realize a rotary damper characterized by an high toughness, and providing a high braking torque, for instance of the order of several tens of N·cm.

Preferred embodiments of the invention are defined in the dependent claims.

Further characteristics and advantages of the device according to invention will become clearer with the following detailed description of some embodiments of the invention with reference to the attached drawings, given with a purely illustrative and not limitative purpose, in which:

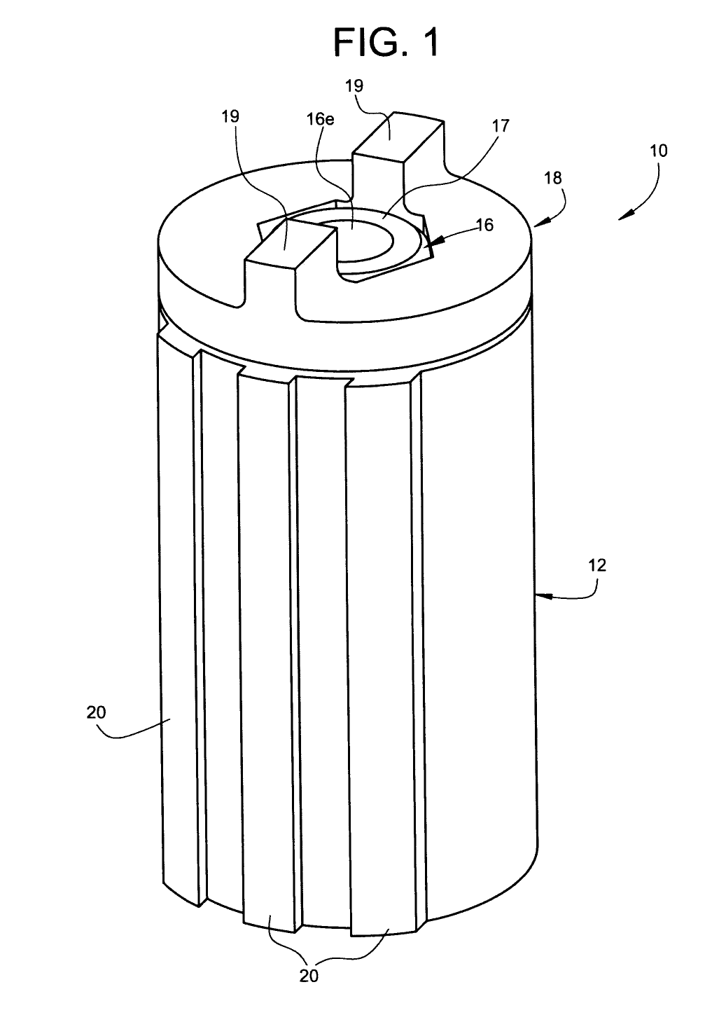

FIG. 1 is a perspective view of a rotary damper according to the invention;

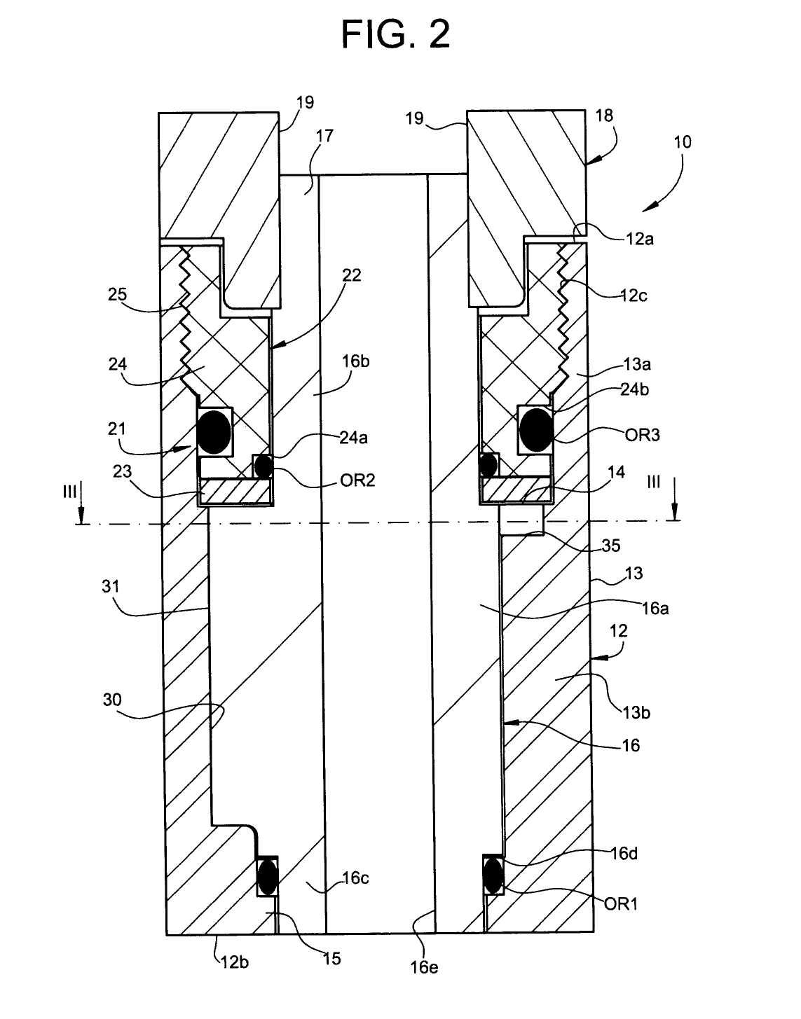

FIG. 2 is a longitudinally sectioned view of the damper of FIG. 1;

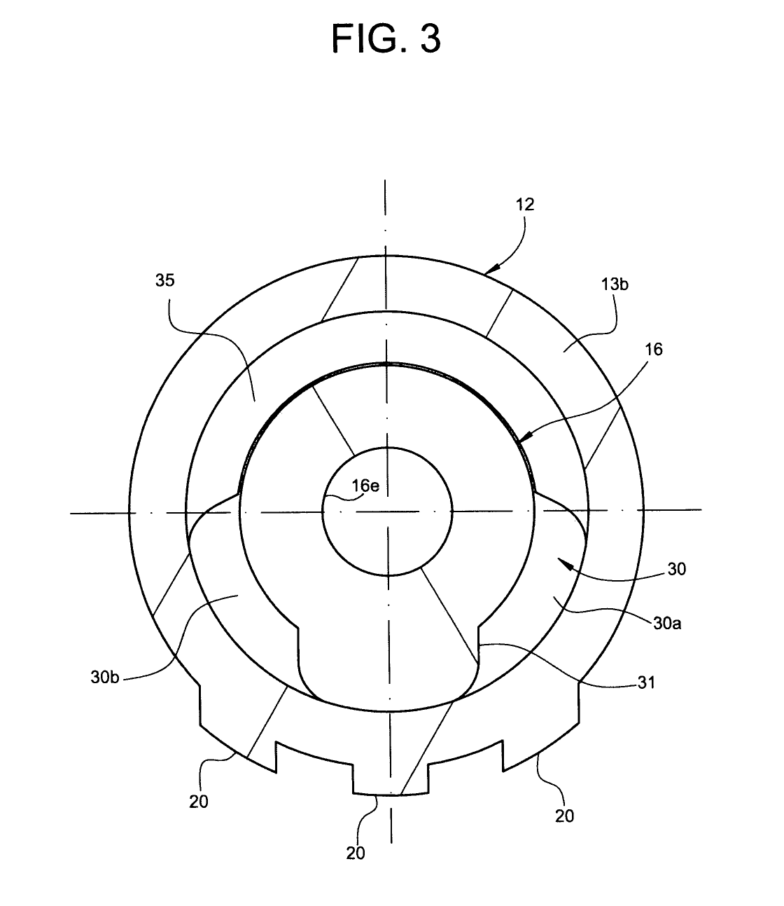

FIG. 3 is a transversely sectioned view of the damper of FIG. 1, taken along line III-III of FIG. 2;

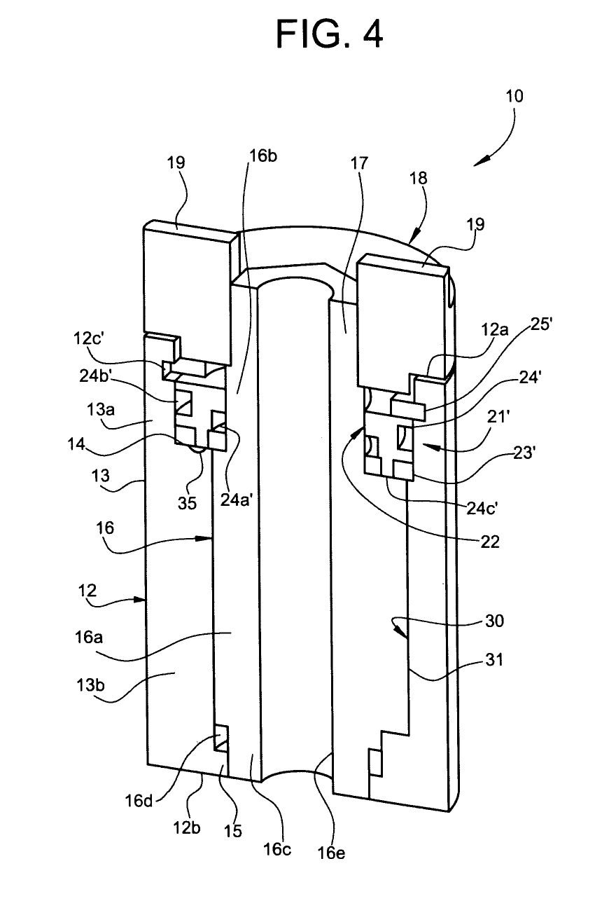

FIG. 4 is a broken view of a second embodiment of a damper according to the invention;

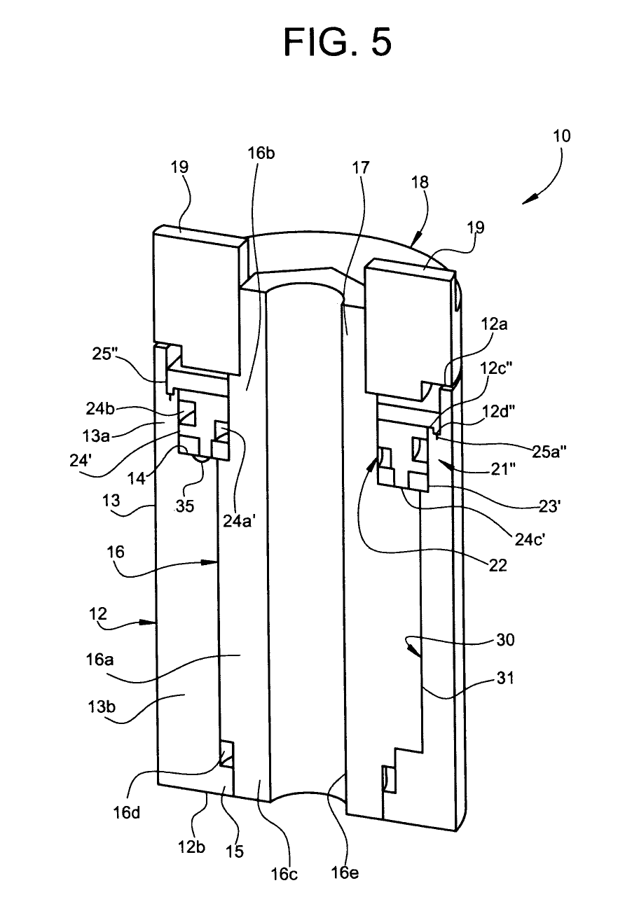

FIG. 5 is a broken view of a third embodiment of a rotary damper according to the invention;

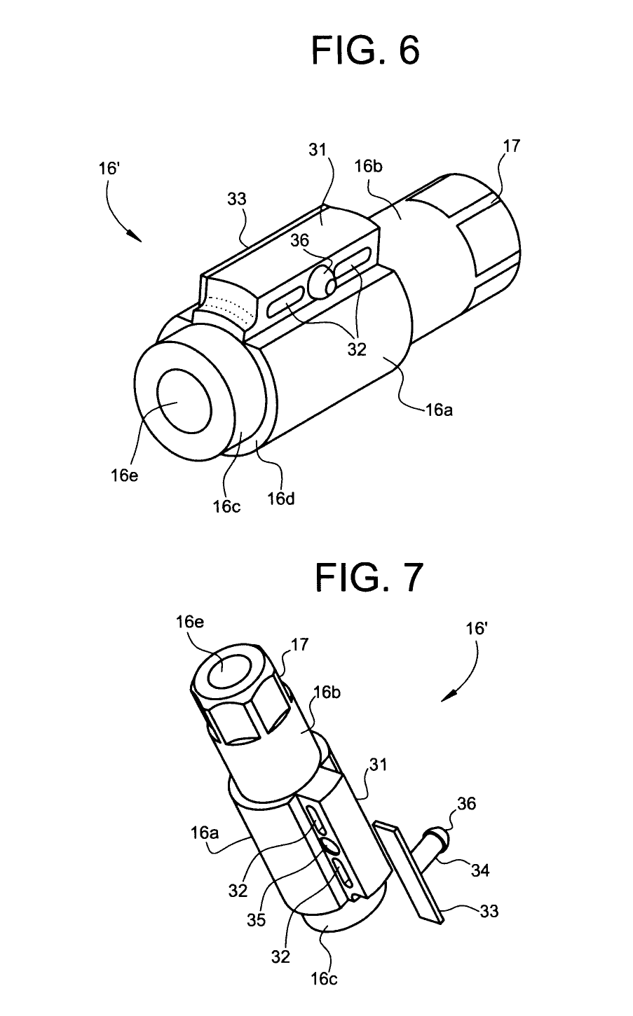

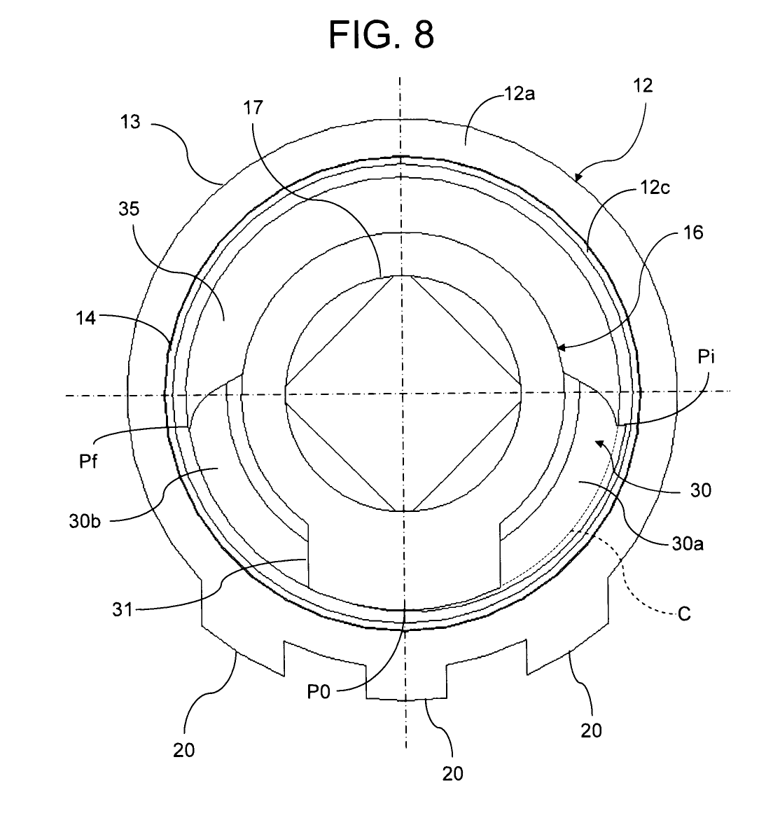

FIGS. 6 and 7 are perspective and exploded views of a rotor of a fourth embodiment of damper; and

FIG. 8 is a plan view of a further embodiment of a damper.

FIGS. 1 to 3 show a rotary damper 10 of the type which is known in the field as “barrel”. Such dampers have the shape of a cylinder, whose outer diameter is generally smaller than the height of the cylinder. The damper 10 is adapted to be applied to a movable member whose movement relative to another element is desired to be slowed down, such as a movable armchair of a motor vehicle seat. Particularly, the device is adapted to be mounted at the rotation or hinge axis of the movable member.

The device 10 includes a cylindrical housing 12, which has a lateral wall 13, and is passed through from one end 12a to the other 12b by a cavity. The lateral wall 13 includes a mouth portion 13a at an axial end 12a and, for the remaining part right to the other axial end 12b, a shoulder portion 13b having a greater thickness than the mouth portion 13a. The shoulder portion 13b has therefore a shoulder surface 14, at which the wall thickness changes from the mouth portion 13a to the shoulder portion 13b.

At the axial end 12b a flange portion 15 furthermore extends from the shoulder portion 13b toward the inside of the cavity of the housing 12. At the other axial end 12a an inner thread 12c is formed in the mouth portion 13a.

The damper 10 further include a rotor 16, which is coaxially mounted within the cylindrical housing 12, and is rotatable with respect thereto. The rotor 16 includes a central portion 16a, having an outer diameter substantially equal to the inner diameter of the cavity of the cylindrical housing 12 at the shoulder portion 13b of the wall 13 of the housing and, at opposite axial ends, it includes end portions 16b and 16c having a smaller outer diameter than the outer diameter of the central portion 16a of the rotor 16. An end portion 16c of the rotor 16 is positioned at the flange portion 15 of the cylindrical housing 12, and has an outer diameter substantially equal to the inner diameter of the cavity of the housing 12 at the flange portion 15; between such end portion 16c and the radially inner surface of the shoulder portion 13b of the housing 12 a seat 16d is provided for receiving an O-ring OR1 for sealing between the rotor 16 and the housing 12. The other end portion 16b of the rotor 16 is positioned at the mouth portion 13a of the cylindrical housing 12, and further comprises a shaft portion 17 protruding from the housing 12, to which a drive element 18 is coupled. Such element 18 has two tongues 19 extending in diametrically opposite radial directions, which conventionally serve to connect the rotor 16 in a rotationally integral way to one of the two elements whose mutual rotation movement is desired to be slowed down. To such end, the housing 12 is also provided with one or more tongues 20, for connection to the other of the two elements. In the rotor 16 a through hole 16e is also formed, which enables the damper 10 to be installed onto the rotation axis or pivot between the two elements whose mutual rotation movement is desired to be slowed down.

The damper 10 includes furthermore a closure assembly 21, which is sealingly mounted on an axial end 12a of the cylindrical housing 12, at the shoulder surface 14 of the shoulder portion 13b of the cylindrical housing 12, and has a through opening 22 through which the shaft portion 17 of the rotor 16 protrudes.

In the example shown in FIGS. 1 and 2, the closure assembly 21 is screwingly mounted on the housing 12, and comprises a washer 23 and a cover 24. The washer 23 is directly positioned on the shoulder surface 14. The cover is mounted on the washer 23 and has, on the radially inner side and on the radially outer side, respective seats 24a and 24b for receiving corresponding O-rings OR2 and OR3. The washer 23 serves to separate the lower O-ring OR2 from the underlying part of the damper. The cover 24 is provided with an outer thread 25 for enabling the cover 24 to be screwed to the inner thread 12c of the lateral wall 13 of the housing 12, and therefore the closure assembly 21 to be mounted.

The cylindrical housing 12, the rotor 16 and the closure assembly 21 cooperate so as to contain a braking chamber 30 (illustrated more clearly in FIG. 3) having an arcuately extending cross section and containing a viscous braking fluid, for instance silicon oil.

Particularly, the braking chamber 30 is entirely formed in the shoulder portion 13b of the lateral wall 13 of the cylindrical housing 12, and is therefore delimited, on the radially outer side, on the bottom side, and on the respective sides at the ends with respect to the rotation direction of the rotor 16, by surfaces formed in such shoulder portion 13b. In its remaining part, the braking chamber 30 is delimited by the rotor 16 (more precisely, by the radially outer surface of the central portion 16a of the rotor) and by the closure assembly 21 (more precisely, by a face of the washer 23) on the radially inner side and on an axial end, respectively.

Besides, the rotor 16 includes a piston element or portion radially extending from the rotor 16, and disposed within the braking chamber 30 in such a way as to separate such chamber into two separate regions 30a, 30b in mutual fluid communication. The piston element or portion 31 is movable integrally with the rotor 16, so that a rotation of the rotor 16 produces a rotary movement of the piston element or portion 31 which is braked by the resistance to the flow of fluid from a region to the other of the braking chamber 30 caused by the movement of the piston element or portion 31. As can be seen in FIG. 2, the meridian section of the piston element or portion 31 is substantially congruent to the meridian section of the braking chamber 30, in such a way as to obstruct it completely.

The fluid communication between the two separate regions 30a, 30b of the chamber 30 is therefore achieved through a channel 35 formed on the shoulder surface 14 of the shoulder portion 13b of the cylindrical housing 12. The channel 35 is interposed between the shoulder portion 13b and the closure assembly 21 (more precisely, between the shoulder portion 13b and the washer 23), and is laterally delimited on one side by a surface of the rotor 16 and on the other side by a surface of the shoulder portion 13b.

In a so configured damper, thanks to the fact that the braking chamber 30 is formed in the shoulder portion 13b of the lateral wall 13 of the housing 12 (that is, in the part of the wall having greater thickness), and that therefore the radially outer surface of the rotor 16 is in contact with the radially inner surface of the housing 12 (except from its part facing on the braking chamber 30), it is possible to get a very tough rotary damper, as well as simple to realize.

The device according to the invention can generally be realized from plastic material or metal. The Applicant has for instance realized a device of the above described type in metal alloy, having an overall diameter of around 20 mm and an overall height of around 30 mm, and capable to achieve a braking torque equal to around 250 N·cm.

FIG. 4 shows a second embodiment of a rotary damper which is substantially similar to the preceding one, but different therefrom due to the different type of closure of the braking chamber. The elements corresponding to those of the preceding embodiment have been designated with same reference numbers, and will not be further described.

The closure assembly of such second embodiment, generally designated with 21′, is locked to the cylindrical housing through an elastic ring instead of being screwingly mounted thereon.

To this end, a groove 12c′ is formed in the mouth portion 13a at the axial end 12a through which the closure assembly 21′ is inserted.

The closure assembly 21′ includes therefore a washer 23′, a cover 24′ and an internal retaining ring 25′. The washer 23′ is directly positioned on the shoulder surface 14. The cover 24′ is mounted on the washer 23′, and is provided with seats 24a′ and 24b′ for receiving corresponding O-rings (not shown), on its radially inner side and on its radially outer side, respectively. The cover 24′ is provided with pin projections 24c′, adapted to be inserted in corresponding holes of the washer 23′ for the mutual positioning of such elements. The elastic ring 25′ is inserted in the groove 12c′ of the lateral wall 13′ of the housing 12′ for locking axially the cover 24′ and the washer 23′.

The present embodiment is different from the preceding one also because of the size of the cross section of the channel 35. Even here the channel 35 is interposed between the shoulder portion 13b and the closure assembly 21′ (more precisely, between the shoulder surface 14 and a face of the washer 23′), but its cross section is completely defined by the shoulder surface 14, and by a corresponding surface of the closure assembly 21′ (the channel 35 in this case is not in contact with the rotor 16).

FIG. 5 shows a third embodiment of rotary damper substantially similar to the second one, but different therefrom for the different type of closure of the braking chamber. The elements corresponding to those of the preceding embodiment have been designated with same reference numbers, and will not be further described.

The closure assembly of such third embodiment, generally designated with 21″, is fixed through welding to the cylindrical housing 12 instead of being mechanically fixed thereto.

Such closure assembly 21″ still includes the washer 23′ and the cover 24′ but comprises a welded retaining element 25″ in place of the internal retaining ring. During assembly, such welded retaining element 25″ is positioned on a welding shoulder 12c″ formed on the mouth portion 13a of the lateral wall 13 of the housing 12, and welded thereto (for instance through ultrasounds), to lock axially the cover 24′ and the washer 23′.

Preferably, the configuration of the joint between welded retaining element 25″ and welding shoulder 12c″ is realized according to the teachings of the international application WO 2007/099508 of the same Applicant. The welding shoulder 12c″ therefore has a circumferential groove 12d″ inside which an elongated energy director 25a″ is welded, which extends circumferentially and in axial direction from a peripheral surface of the welded retaining element 25″.

In FIGS. 6 and 7 a rotor 16′ of a fourth embodiment of rotary damper according to the invention is shown. The elements corresponding to those of the preceding embodiments have been designated with same reference numbers, and will not be further described. Such rotor 16′ may be combined without distinction with a damper according to any one of the previously shown embodiments, or with other embodiments conceivable by the skilled person, and it has the special feature of conferring unidirectionality to the damper.

In particular, the piston element or portion 31 of the rotor 16′ has one or more through openings 32 that extend through the thickness of such piston element or portion 31 in the direction of movement thereof (that is, in the circumferential direction). Furthermore, a plate 33 of flexible material, for instance a plate of elastomeric material, is mounted on one of the sides of the piston element or portion 31, and is arranged in such a way as to cover the through openings 32. The mounting of the plate 33 is made possible by a pin 34 integrally formed with the plate 33, which is inserted in a mounting through hole 35 formed in the piston element or portion 31, and has a head 36 having a greater diameter than the diameter of the pin, which serves to allow the system plate-pin to be locked when the pin 34 is completely inserted in the through hole 35.

When the rotor 16 moves in the working direction (clockwise, according to FIG. 7) the plate 33 is forced to adhere to the wall of the piston element or portion 31 by the pressure of the liquid: in this way all openings 32 are closed and the rotor 16 can work.

In the opposite direction (counterclockwise, according to FIG. 7) the liquid flowing through the openings 32 forces the plate 33 to bend; the plate 33 cannot detach because it is retained by the pin 34, but bends allowing the liquid to seep through the openings 32 and causing pressure to fall down. In this way the rotor does not work and its movement is free (provided that the overall section of the through openings is great with respect to the section of the channel 35).

FIG. 8 shows a further embodiment of a rotary damper, similar to that of FIGS. 1 to 3. In the view of FIG. 8 the damper is shown in plan view and in open condition, that is without the closure assembly. Elements corresponding to those of the first embodiment have been designated with same reference numbers, and will not be further described.

The damper of FIG. 8 is different from that of FIGS. 1 to 3 because of minor features, such as that the rotor 16 is lacking of a central through hole (the damper having therefore different installation conditions) and has a differently shaped shaft portion 17. However, the essential difference is constituted by the fact that the braking chamber 30 has a width (in the radial direction) that is varying along the movement path of the piston element or portion 31. In particular, the braking chamber has a width decreasing from an end Pi of the movement path of the piston element or portion 31 to a position P0 of this movement path in which the width of the chamber has its lowest value (the width being therefore constant from here to the other end Pf of the path of the piston element or portion 31). In the position P0 (and in the other positions comprised between the position P0 and the end Pf) the piston element or portion 31 is substantially congruent to the meridian section of the braking chamber 30. As shown in FIG. 8, the width variation of the chamber 30 is achieved by forming the chamber, into the shoulder portion 13b of the housing 12, in such a way as that the surface delimiting it on the radially outer side has a trace in the transverse plane different from a circle arc centered on the rotation axis of the rotor (this theoric circle arc is shown in FIG. 8 through a dashed line C), in the segment comprised between the points P1 and P0. In this way a rotary damper is obtained, which is characterized by a varying braking torque having a minimum at the end Pi, in which there exists some clearance between the radial end of the piston element or portion 31 and the lateral wall 13 of the housing 12 (and so there exists some flow of fluid), and having a maximum at the movement positions comprised between the position P0 and the end position Pf, wherein the meridian section of the braking chamber 30 is completely obstructed by the piston element or portion 31.

It is intended that the invention is not limited to the embodiments herein described and illustrated, but it is instead susceptible of modifications relating to form and arrangement of parts, constructive and operative details. Particularly, elements shown in relationship to some of the embodiments herein described can be combined with elements of the other described embodiments, or of further embodiments conceivable by the skilled person.

1. A rotary damper, comprising:
a cylindrical housing, having a lateral wall provided with a shoulder portion;
a rotor, which is coaxially mounted within the cylindrical housing, and is rotatable relative thereto;
a closure assembly, which is sealingly mounted onto an axial end of the cylindrical housing at a shoulder surface of the shoulder portion of the cylindrical housing, and has a through opening through which a shaft portion of the rotor protrudes;
in which said cylindrical housing, rotor and closure assembly cooperate so as to contain a braking chamber having an arcuately extending transverse section and containing a viscous braking fluid,
in which the rotor comprises a piston element or portion extending radially from the rotor, and arranged within the braking chamber so as to separate said chamber into two separate regions in mutual fluid communication, said piston element or portion being integrally movable with the rotor, so that a rotation of the rotor produces a rotary movement of the piston element or portion which is braked by the resistance to the flow of fluid from a region to the other of the braking chamber caused by the movement of the piston element or portion; and
in which
the fluid communication between the two separate regions of the chamber is obtained through a channel formed on the shoulder surface of the shoulder portion of the cylindrical housing, said channel being interposed between said shoulder portion and the closure assembly;
wherein
the braking chamber is formed in the thickness of the shoulder portion of the lateral wall of the cylindrical housing, and is delimited on the radially inner side and on an axial end by the rotor and by the closure assembly, respectively.

2. A damper according to claim 1, in which said chamber has a width in the radial direction that is constant along the movement path of the piston element or portion.

3. A damper according to claim 1, in which said chamber has a width in the radial direction that is varying along the movement path of the piston element or portion.

4. A damper according to claim 3, in which said chamber has a width in the radial direction that decreases from one end (Pi) of the movement path of the piston element or portion to a position (P0) of this movement path in which said width has a minimum.

5. A damper according to claim 1, in which the closure assembly comprises a washer directly positioned on the shoulder surface, a cover mounted on the washer and provided for realizing a seal with the rotor on one side and with the cylindrical housing on the other, said cover being screwingly mounted to the cylindrical housing.

6. A damper according to claim 1, in which the closure assembly comprises a washer directly positioned on the shoulder surface, a cover mounted on the washer and provided for realizing a seal with the rotor on one side and with the cylindrical housing on the other, and a retaining element connected to the cylindrical housing so as to lock axially the cover and the washer.

7. A damper according to claim 6, in which the cover is provided with pin projections, inserted into corresponding positioning holes of the washer.

8. A damper according to claim 6, in which the closure assembly is mechanically fixed to the cylindrical housing, and the retaining element is constituted by an internal retaining ring, inserted into a groove formed in the lateral wall of the cylindrical housing.

9. A damper according to claim 6, in which the closure assembly is fixed through welding to the cylindrical housing, and the retaining element is constituted by a welded retaining element, welded on a welding shoulder formed on the lateral wall of the cylindrical housing.

10. A damper according to claim 9, in which the welding shoulder has a circumferential groove inside which an elongated energy director is welded, said director extending circumferentially and in axial direction from a peripheral surface of the welded retaining element.

11. A damper according to claim 1, in which said piston element or portion has one or more through openings extending through the thickness thereof in the circumferential direction, and in which on one of the sides of the piston element or portion a plate of flexible material is arranged, said plate being realized in such a way as that, in a rotation direction of the rotor, said plate is bent away from the piston element or portion because of the viscous fluid flowing through the through openings, whereas in the opposite rotation direction said plate is thrust by the viscous fluid against the piston element portion thereby closing said through openings.

12. A damper according to claim 2, in which the closure assembly comprises a washer directly positioned on the shoulder surface, a cover mounted on the washer and provided for realizing a seal with the rotor on one side and with the cylindrical housing on the other, said cover being screwingly mounted to the cylindrical housing.

13. A damper according to claim 3, in which the closure assembly comprises a washer directly positioned on the shoulder surface, a cover mounted on the washer and provided for realizing a seal with the rotor on one side and with the cylindrical housing on the other, said cover being screwingly mounted to the cylindrical housing.

14. A damper according to claim 4, in which the closure assembly comprises a washer directly positioned on the shoulder surface, a cover mounted on the washer and provided for realizing a seal with the rotor on one side and with the cylindrical housing on the other, said cover being screwingly mounted to the cylindrical housing.

15. A damper according to claim 2, in which the closure assembly comprises a washer directly positioned on the shoulder surface, a cover mounted on the washer and provided for realizing a seal with the rotor on one side and with the cylindrical housing on the other, and a retaining element connected to the cylindrical housing so as to lock axially the cover and the washer.

16. A damper according to claim 3, in which the closure assembly comprises a washer directly positioned on the shoulder surface, a cover mounted on the washer and provided for realizing a seal with the rotor on one side and with the cylindrical housing on the other, and a retaining element connected to the cylindrical housing so as to lock axially the cover and the washer.

17. A damper according to claim 4, in which the closure assembly comprises a washer directly positioned on the shoulder surface, a cover mounted on the washer and provided for realizing a seal with the rotor on one side and with the cylindrical housing on the other, and a retaining element connected to the cylindrical housing so as to lock axially the cover and the washer.

18. A damper according to claim 7, in which the closure assembly is mechanically fixed to the cylindrical housing, and the retaining element is constituted by an internal retaining ring, inserted into a groove formed in the lateral wall of the cylindrical housing.

19. A damper according to claim 7, in which the closure assembly is fixed through welding to the cylindrical housing, and the retaining element is constituted by a welded retaining element, welded on a welding shoulder formed on the lateral wall of the cylindrical housing.
